(19) United States
(12) Patent Application Publication
(10) Pub. No.: US 2007/0106587 A1
(43) Pub. Date: May 10, 2007

(54) Exchange traded fund formed from at least two underlying indexes

(76) Inventors: Brian Scott Orloske, Houlton, WI (US); Eric John Orloske, St. Paul, MN (US)

Correspondence Address: MERCHANT & GOULD PC, P.O. BOX 2903, MINNEAPOLIS, MN, 55402-0903, US

(21) Appl. No.: 11/269,404

(22) Filed: Nov. 7, 2005

(51) Int. Cl. G06Q 40/00

(52) U.S. Cl. 705/36 R

(57) ABSTRACT

The invention is directed towards systems and methods for trading a portion of a pool of assets formed from one or more groups of assets. Two or more groups of assets are combined into an asset pool such that the asset pool includes the same assets as the two or more asset groups in similar proportions. The asset pool is then divided into various trading units. Generally, each trading unit can be bought and sold individually or in groups. In some embodiments, the trading unit can be bought and sold via a public exchange such as a stock exchange. In some embodiments, the groups of assets include stock indexes.

### TECHNICAL FIELD

The invention relates to an exchange traded fund, and more particularly to an exchange traded fund formed from at least two underlying indices.

### BACKGROUND

An Exchange Traded Fund (“ETF”) is a security that includes multiple stocks, similar to a mutual fund, but trades on a stock exchange like an ordinary stock. Because the ETF is bought and sold via the stock exchange, the price of the ETF changes constantly and each transaction typically has a commission cost. In contrast, mutual funds are typically bought and sold only at the closing Net Asset Value of the mutual fund.

Exchange Traded Funds grant investors much flexibility. Investors can buy and sell an ETF like any ordinary stock by using limit orders, stop losses, buying on margin, and other options. Generally, ETF's have little or no minimum investment requirement. The ETF also has some of the advantages of a mutual fund, enabling users to diversely invest in different segments of the market. Unlike a mutual fund, ETF's are generally passively managed and, hence, have lower operating expenses. Stocks are added and deleted from mutual funds at the discretion of a trustee or similar caretaker. In contrast, stocks generally are added and deleted from a passively managed ETF on a non-discretionary basis only when an external event occurs. The trustee of the ETF makes no independent judgment regarding the stock content of the ETF.

### SUMMARY

An exchange-traded fund according to one embodiment of the invention includes two or more groups of assets combined into an asset pool such that the asset pool includes substantially the same assets as the asset groups in substantially the same proportions.

A method for trading an exchange traded fund according to one embodiment of the invention includes creating a trust, passively managing the trust, dividing the trust into multiple depository receipts, and trading the depository receipts on a security exchange. The trust is created by obtaining shares in substantially all of the stocks in at least two underlying indices, and pooling all obtained stocks into the trust. The trust is passively managed by adding stocks to and deleting stocks from the trust to conform to periodic changes in identity to the at least two underlying indices. Each depository receipt represents an undivided ownership interest in the trust.

In one embodiment, the trust is created by obtaining substantially all stock included in the S&P 500 Index, obtaining all stocks included in the NASDAQ Composite Index, obtaining all stocks included in the Dow Jones Industrial Average Index, obtaining all stocks included in the Russell 2000 Index. In such an embodiment, the trust is passively managed by adding stocks to and deleing stocks from the trust to conform to periodic changes in the identity of the S&P 500 Index, the NASDAQ Composite Index, the Dow Jones Industrial Average Index, and the Russell 2000 Index.

### BRIEF DESCRIPTION OF THE DRAWINGS

FIG. 1 is a schematic representation of methods and systems for compiling and dividing assets according to one embodiment of the present disclosure;

FIG. 2 is a schematic representation of a computing system that may be used to implement aspects of the present disclosure;

FIG. 3 is a schematic representation of the composition of an exchange traded fund according to one embodiment of the present disclosure;

FIG. 4 illustrates an operation flow chart for creating and trading an exchange traded fund on a security exchange according to one embodiment of the present disclosure;

FIG. 5 illustrates an operation flow chart for passively managing an exchange traded fund;

FIG. 6 illustrates an operation flow chart for determining the value of a depository receipt according to one embodiment of the present disclosure;

FIG. 7 illustrates an operation flow chart for determining the value of an underlying security index according to one embodiment of the present disclosure; and

FIG. 8 illustrates an operation flow chart for trading a sector fund on a security exchange in accordance with one embodiment of the present disclosure.

### DETAILED DESCRIPTION

In general, the present disclosure relates to an exchange traded fund. Preferably, the exchange traded fund is formed from a plurality of indexes. The combined plurality of indexes can be filtered according to a set of criteria to form the exchange traded fund. For example, one criteria for filtering can be by a certain industry.

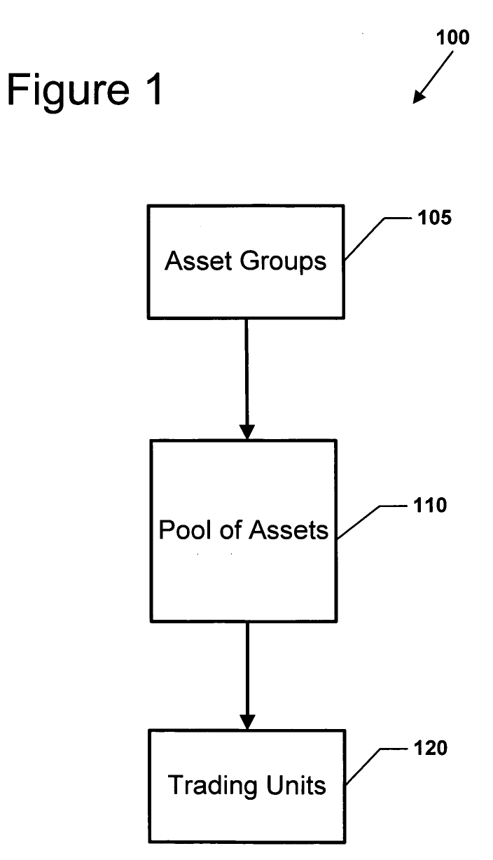

Referring now to FIG. 1, FIG. 1 illustrates a schematic representation of methods and systems 100 for trading a portion of a pool of assets formed from one or more groups of assets. Asset groups 105 are combined into an asset pool 110 such that the asset pool 110 includes the same assets as the asset groups 105 in similar proportions. The asset pool 110 is then divided into trading units 120. In some example embodiments, the trading units 120 represent equal, undivided ownership interests in the trust. Generally, each trading unit 120 can be bought and sold individually or in groups. In some embodiments, the trading units 120 can be bought and sold via a public exchange such as a stock exchange.

In various example embodiments, groups of assets 105 can include indexes, mutual funds, stock portfolios, and other such groupings of assets. In some example embodiments, the assets included in an asset group 105 might share common properties. In some other example embodiments, all of the assets in a group 105 can be distributed by companies having similar characteristics, such as an industry. For example, in one embodiment, all of the assets in an asset group 105 are shares in various types of stock in the same company. In another example embodiment, all of the assets in an asset group 105 are common stocks in related companies. In yet another embodiment, all of the assets in an asset group 105 are shares of stock in companies within a single industry. In still yet another embodiment, all of the assets in the first asset group 105 are shares of stock in companies of similar size or economic growth potential.

In some example embodiments, all of the trading units 120 include substantially the same composition of assets in substantially the same proportions. In some other embodiments, two or more groups of trading units 120 are formed from the asset pool 110 using filter criteria, each group having similar assets in similar proportions.

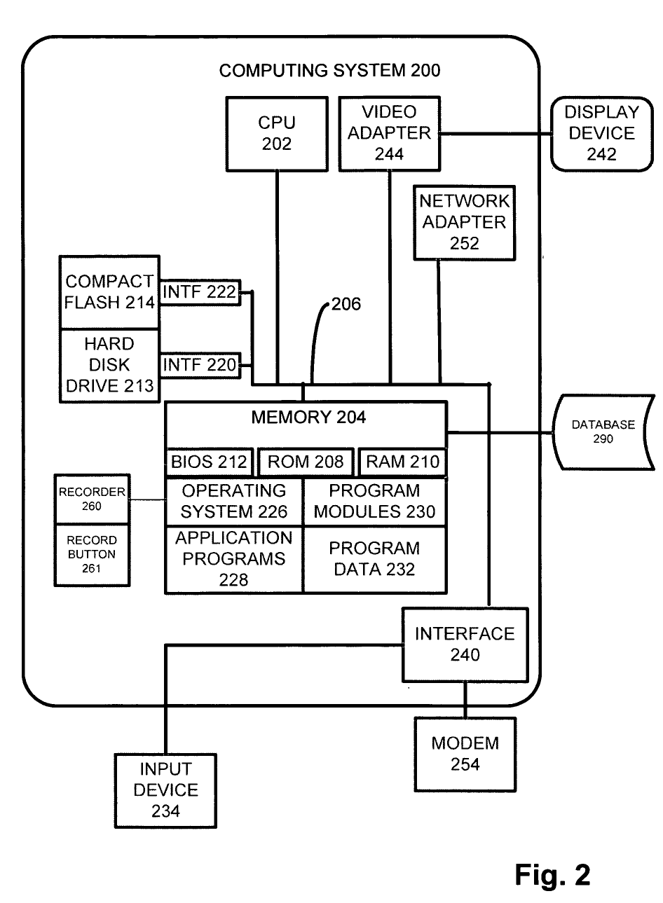

Referring now to FIG. 2, an exemplary environment for implementing embodiments of the present disclosure includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

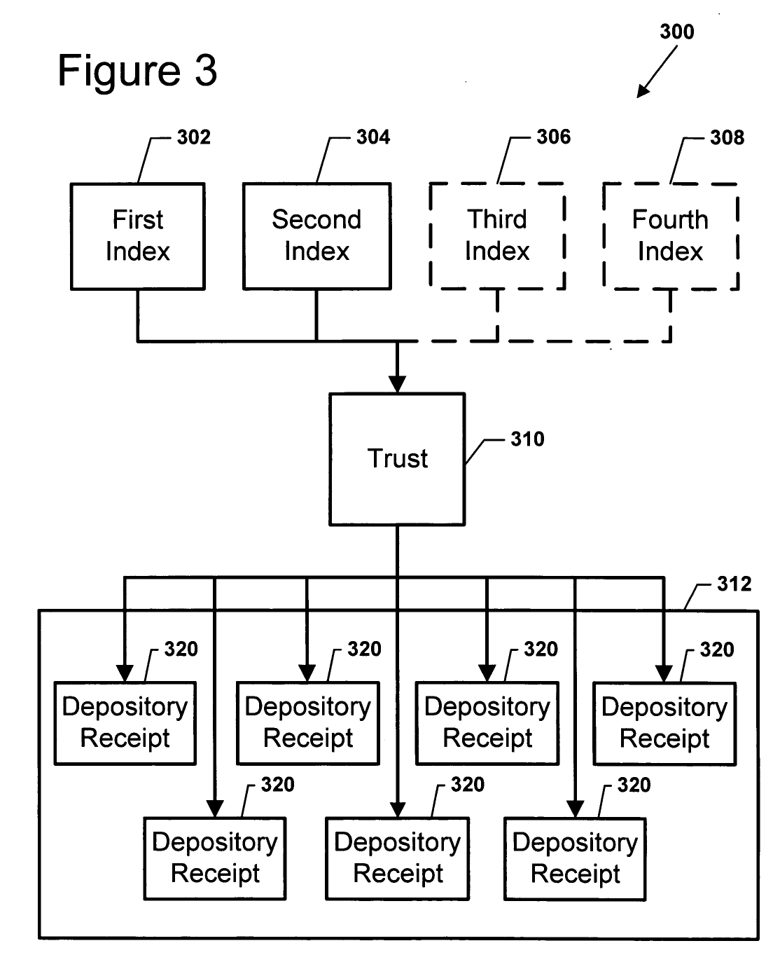

Referring now to FIG. 3, the present disclosure relates to an exchange traded fund system 300. In one example embodiment, preferably, the exchange traded fund system includes a unit investment trust 310, registered under the Investment Company Act of 1940 that provides investors with the opportunity to purchase a security representing a proportionate undivided interest in a portfolio of securities designed to generally correspond to the net price and yield performance of two or more underlying indexes 302, 304. In some example embodiments, the security corresponds to a plurality of underlying indexes, such as four underlying indexes 302, 304, 306, 308. Of course, any number of underlying indexes or asset groups could be used. In one example embodiment, the four underlying indexes are the Dow Jones Industrial Average Index (“the Dow Jones Index”) 302, the Russell 2000 Index 304, the Standard & Poor's 500 Composite Price Index (“the S&P Index”) 306, and the NASDAQ Composite Index 308.

Preferably, the trust 310 holds shares in substantially all of the common stock, in substantially the same composition and weighting, of the underlying indices 302, 304, 306, 308 and forms an exchange-traded fund 312. Each unit of fractional undivided interest in the trust 310 is referred to as a depository receipt 320. Individual depository receipts 320 are listed to trade on a security exchange (e.g., a stock exchange) at prices established throughout the trading day, similar to any other equity security trading in the secondary market on an exchange.

In some example embodiments, the composition and weighting of the underlying indexes, such as underlying indexes 302, 304, 306, 308 of FIG. 3, is determined and adjusted by each respective index on a discretionary basis. Generally, each underlying index determines the criteria for inclusion in the index in order to substantially replicate the investment profile of a particular subset of investments. Each index also adjusts the composition and weighting of the index in order to track the changing investment profile of the particular subset.

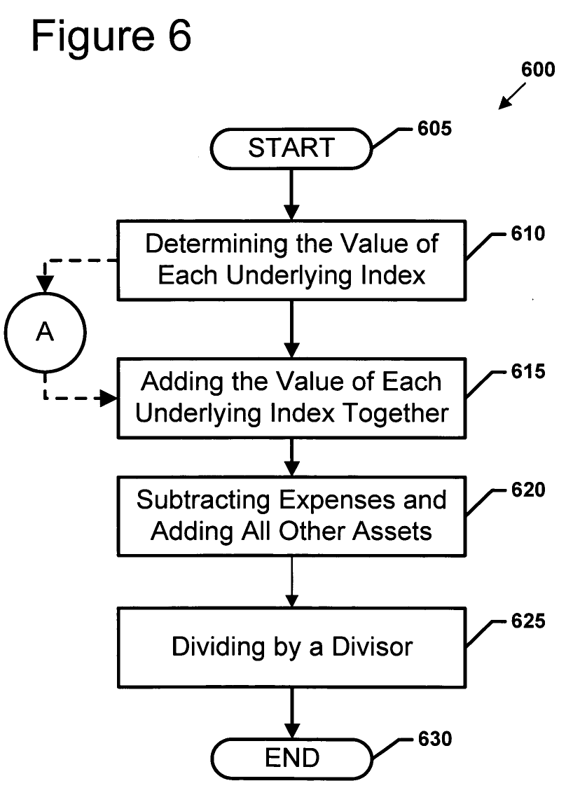

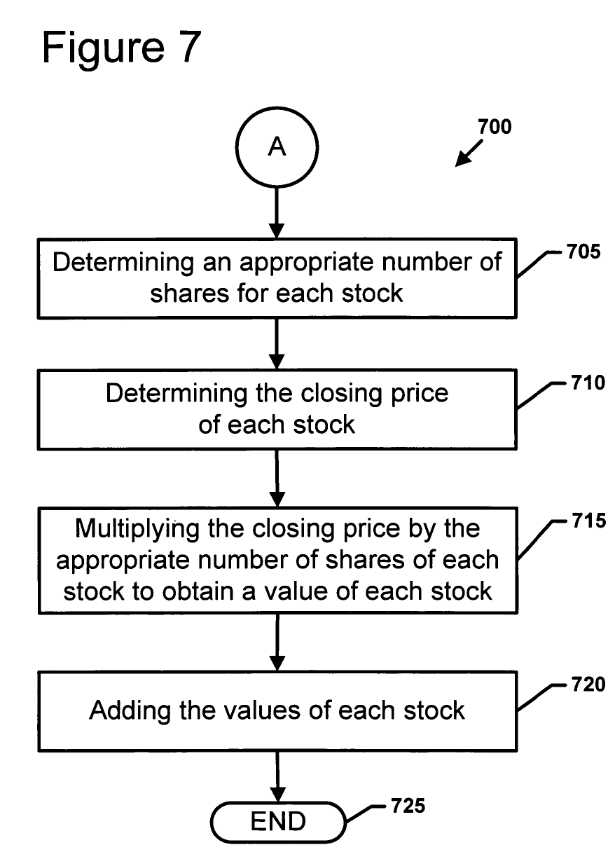

For example, the Russell 2000 Index is composed of two thousand stocks selected to represent the investment profile of the small cap segment of the U.S. equity markets. Generally, the Russell 2000 Index determines a stock's inclusion in the Index The Russell 2000 Index is reconstituted annually to ensure larger stocks do not distort the performance and characteristics of the small-cap opportunity set. The component weighting of the Russell 200 Index is based on the float-adjusted total market capitalization weighting process, which is discussed herein with respect to FIGS. 6 and 7.

As another example, the NASDAQ Composite Index attempts to represent the performance of all NASDAQ domestic and international based common stocks listed on the NASDAQ stock market. The NASDAQ Composite Index is market value weighted. The representation of each security in the Index is proportional to its last sale price multiplied by the total number of shares outstanding, relative to the total market value of the respective index.

As yet another example, the Dow Jones Index is composed of thirty stocks, all of which are listed on the Exchange, the NYSE, or the NASDAQ. No specific rules determine inclusion of a company in the index. Rather, the Dow Jones Index is maintained and reviewed on a discretionary basis by editors of The Wall Street Journal. The Dow Jones Index is price weighted rather than market capitalization weighted. The component weightings are, therefore, affected only by changes in the stocks' prices, in contrast with other indexes' weightings that are affected by both price changes and changes in the number of shares outstanding.

As still yet another example, the S&P Index is composed of five hundred stocks, all of which are listed on the Exchange, the New York Stock Exchange (“NYSE”), or the NASDAQ. The S&P Index attempts to represent the investment profile of the large-cap segment of the U.S. equity markets. The S&P Index is maintained by a committee which determines whether adjustment to the composition or weighting of the index is desirable. The component weighting of the S&P Index is also calculated using the float-adjusted market capitalization weighting process.

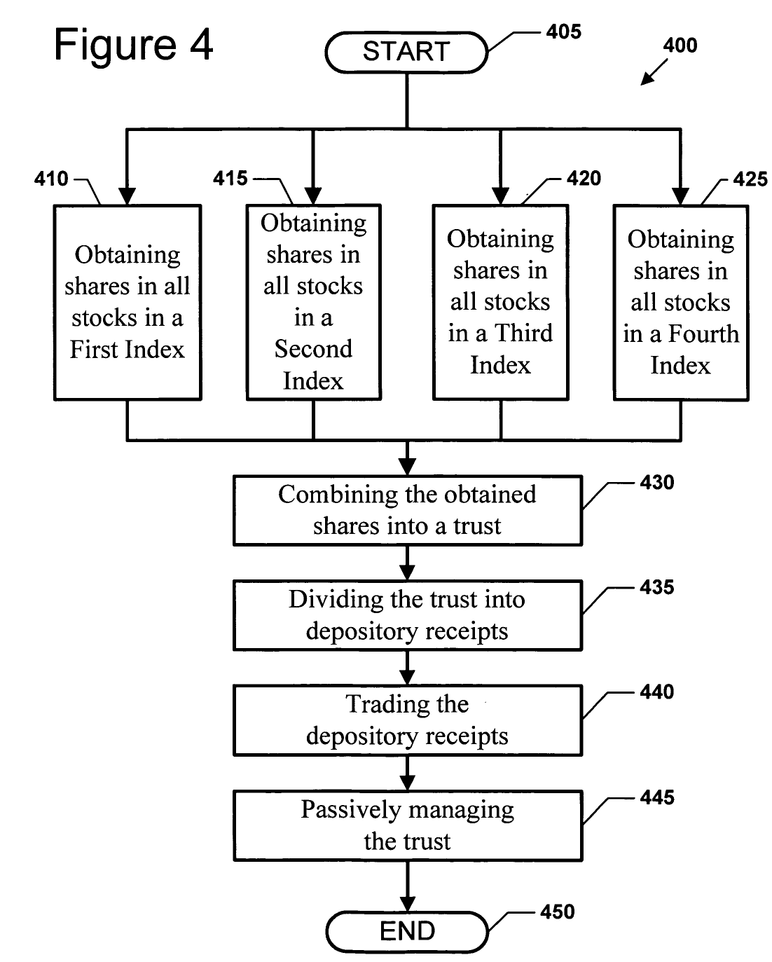

Referring now to FIG. 4, in general, the trust, for example, the trust 310 of FIG. 3, is created by combining shares of substantially all of the common stock from the underlying indices according to the component weightings of each of the underlying indexes. FIG. 4 illustrates an operation flow chart depicting an example process 400 for creating and trading an exchange-traded fund, such as the exchange traded fund 300 shown in FIG. 3, on a security exchange. The process 400 begins at operation 405 and proceeds to first, second, third, and fourth obtain operations 410, 415, 420, and 425. These obtain operations 410, 415, 420, and 425 include obtaining shares in substantially all common stocks from the underlying indexes, such as the index 302, the index 304, the index 306, and the index 308, respectively, of FIG. 3. The shares are obtained in substantially the same composition and weighting as the shares of stock held in the underlying indices. Of course, shares could also be obtained from other indexes (e.g., the Russell 1000, the S&P Midcap 400, and other such indexes).

Operation flow then proceeds to operation 430 in which the obtained stock is combined into a trust, such as trust 310 of FIG. 3. A divide operation 435 divides the trust into multiple trading units, such as the depository receipts 320 of FIG. 3. Each trading unit is traded on a security exchange in trading operation 440 for a market-determined price. In some example embodiments, the trust issues and redeems the trading units only in specified large lots often referred to as creation units. In one embodiment, a creation unit can include 50,000 trading units or multiples thereof. In another example embodiment, fractional creation units can be created or redeemed.

In some example embodiments, the creation units are issued by the trust to anyone who deposits with a Trustee, a specified portfolio of index securities and a cash payment generally equal to dividends (i.e., or net of expenses) accumulated up to the time of deposit. Upon receipt of one or more creation units, the trust delivers to the redeeming holder a portfolio of securities based on the net asset value of the trust, together with a cash payment. Each redemption is accompanied by a cash redemption payment that on any business day is an amount identical to a cash component of a portfolio deposit.

In some example embodiments, when the Trustee determines that one or more securities are likely to be unavailable, or available in insufficient quantity, for delivery upon creation of the creation units, the Trustee permits the cash equivalent value of one or more of the securities to be included in the portfolio deposit as a part of the cash component in lieu thereof. In some other example embodiments, if a creator is restricted by regulation or otherwise from investing or engaging in a transaction in one or more securities, then the Trustee permits the cash equivalent value of such securities to be included in the portfolio deposit based on the market value of such securities as of the date the creation order is deemed received by a Broker Dealer, or other similar entity, as part of the cash component in lieu of the inclusion of such securities in the stock portion of the portfolio deposit.

In some other example embodiments, if the Trustee determines that one or more securities are likely to be unavailable or available in insufficient quantity for delivery by the trust upon the redemption of creation units, the Trustee may deliver the cash equivalent value of one or more of these securities, based on their market value as of the date the redemption order is deemed received by the Trustee, as part of the cash redemption payment in lieu thereof.

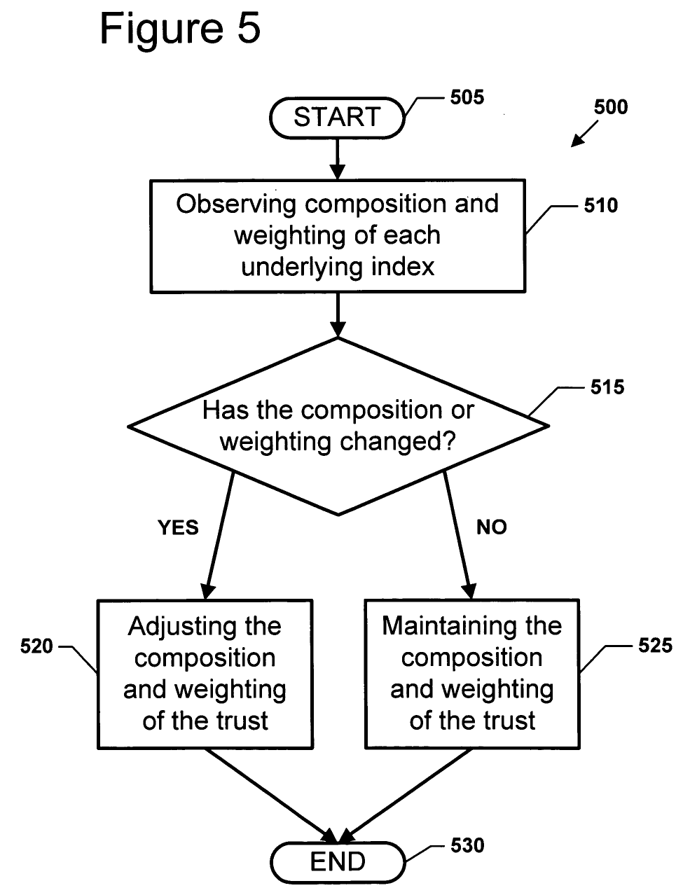

Referring to FIG. 4, a passive operation 445 passively manages the trust throughout the life of the trust. Stocks are added to and deleted from the trust on a non-discretionary basis. Component weighting of the stocks is also determined and adjusted on a non-discretionary basis. An example of such passive management is discussed herein with reference to FIG. 5. The process 400 ends at operation 450.

Referring to FIGS. 3 and 4, FIGS. 3 and 4 can best be understood by explaining some example applications. For one example, in FIG. 3, the First Index 302 may include equal numbers of shares of stocks in companies A, B, C, and D and the Second Index 304 may include equal numbers of shares of stocks in companies E, and F. The trust 310, therefore, would include shares of stocks in companies A, B, C, D, E, and F. However, one-quarter of the shares of the stocks of the trust 310 would be in company E and one-quarter of the shares of the stocks of the trust 310 would be in company F, ignoring the third and fourth indexes 306, 308 for purposes of this example. One-eighth of the shares of the stocks of the trust 310 would be in company A and the last three one-eighths of the shares of stocks of the trust 310 would be in companies B, C, and D, respectively. Of course, in another example, the First and Second Indexes may include unequal shares of stocks in companies A, B, C, D, and E, F, respectively.

In a second example, in FIG. 4, first obtaining operation 410 includes obtaining shares in all of the stocks included in the First Index, for example, the Dow Jones Industrial Average Index (“the Dow Jones Index”). Of course, the First Index could also include the S&P 500 Index, the Russell 2000 Index, the NASDAQ Composite Index, or any other such index. In the example in which the First Index includes the Dow Jones Index, obtaining operation 410 includes obtaining shares in all of the stocks included in the Dow Jones Index in the same proportion and weighting as the shares are held in the Dow Jones Index. An example of obtaining stocks in proportion to the stocks of an underlying index is given in the preceding example. Second, third, and fourth obtaining operations 415, 420, 425 can be performed in substantially the same way to obtain stock in the S&P 500 Index, the Russell 2000 Index, and the NASDAQ Composite Index.

Continuing with the second example, combining operation 430 combines the obtained shares of all stocks in the Dow Jones Index, the S&P 500 Index, the Russell 200 Index, and the NASDAQ Composite Index into a trust, such as the trust 310 of FIG. 3 discussed in the preceding example. Of course, the shares can be combined into any suitable type of asset pool. Dividing operation 435, which divides the trust into depository receipts, includes forming an initial quantity of depository receipts having a value based on the valuation of the Dow Jones Index, the valuation of the S&P 500 Index, the Russell 2000 Index, and the NASDAQ Composite Index. In one example, dividing operation 435 includes forming 50,000 depository receipts. Trading operation 440 includes trading one or more of the depository receipts on an exchange, such as the New York Stock Exchange. Operation 445 includes passively managing the trust. Examples of passive management are discussed below.

Preferably, a Trustee maintains the trust's accounting records, acts as custodian and transfer agent to the trust, and provides administrative services, including filing of all required regulatory reports. The Trustee is also responsible for determining the composition of the portfolio of securities that must be delivered and/or received in exchange for the issuance and/or redemption of creation units of the trust, and for adjusting the composition of the trust's portfolio from time to time to conform to changes in the composition and/or weighting structure of the four underlying indices, such as the underlying indexes 302, 304, 306, 308 of FIG. 3.

Referring to FIG. 5, preferably, securities are added to and deleted from the trust on a non-discretionary, automatic basis only when external events occur. FIG. 5 illustrates an operation flow for an example process 500 for passively managing the trust. The process starts at module 505 and proceeds to observing operation 510. Observing operation 510 observes (i.e., or tracks) the composition of each of the underlying indexes, such as the underlying indexes 302, 304, 306, 308 of FIG. 3. Determining operation 515 determines whether the composition of any of the underlying indexes has changed. If the composition of any of the underlying indexes has changed, then the process 500 proceeds to adjusting operation 520, which adjusts the composition of the trust to reflect the changed composition of the underlying index. If the composition of the underlying indexes has not changed, then the process 500 proceeds to maintaining operation 525, which maintains the composition of the trust. The operation ends at module 530. In this manner, the trust, such as trust 310 of FIG. 3, can be automatically adjusted based on changes to the underlying indexes, such as indexes 302, 304, 306, 308 of FIG. 3. Thus, the trust is passively managed.

The adverse financial condition of any one security issuer does not require the sale of securities from the trust portfolio. Rather, the Trustee, on a non-discretionary basis, adjusts the composition of the portfolio to conform to changes in the composition and/or weighting structure of the underlying indices.

For example, periodically (typically, several times per quarter), the underlying indexes, such as the underlying indexes 302, 304, 306, 308 of FIG. 3, may determine that the total shares outstanding of the component securities of the indices have changed due to secondary offerings, repurchases, conversions or other corporate actions. Periodically, the underlying indexes might determine that the available float shares of one or more of the component securities have changed due to corporate actions, purchases or sales of securities by holders or other events. Additionally, one or more of the underlying indexes might periodically (typically, several times per quarter) replace one or more component securities in the particular index due to mergers, acquisitions, bankruptcies, or other market conditions, or if the issuers of such component securities fail to meet the criteria for inclusion in the particular index.

To maintain the correspondence between the composition and weightings of stocks held by the trust and the stocks composing the underlying indices, a Trustee may adjust the portfolio of the trust from time to time to conform to periodic changes in the identity (i.e., a substitution of one security for another) and/or relative weightings of the underlying indices as shown in adjusting operation 520 of FIG. 5.

In some example embodiments, the Trustee aggregates these adjustments and makes changes to the portfolio of the trust at least monthly. In one example embodiment, the Trustee makes changes whenever significant changes are made to one or more of the underlying indexes. Any change in the identity or weighting of any of the underlying indexes results in a corresponding adjustment to the composition or weighting of the trust portfolio.

In some example embodiments, replicating identically the share composition of the underlying indexes, such as the underlying indexes 302, 304, 306, 308 of FIG. 3, would not be economically efficient. For example, in some example embodiments, the transaction costs incurred by the trust in adjusting the trust portfolio would exceed the expected variation between the composition of the portfolio and one or more of the underlying indexes. In such a case, the portfolio may not be adjusted. Of course, there could be a stated accepted variance tolerance from the composition of the underlying indexes.

In some example embodiments, the Trustee can adjust the composition of the portfolio at any time that the weighting of any security in the portfolio varies in excess of a variation, such as one hundred and fifty percent (150%), of a specified misweighting percentage from the weighting of the security in one of the underlying indices. In one example embodiment, the Trustee adjusts the portfolio when the security in the portfolio varies in excess of 150% of a percentage ranging intermediate 8/100 of 1% to 2/100 of 1%, inclusive, of the specified misweighting percentage. Any suitable variance could be used.

In some example embodiments, the Trustee performs a weighting analysis to examine each stock in the trust's portfolio on each business day, comparing each security's weighting in the portfolio to the weighting of a corresponding security in each underlying index based on prices at the close of the market on the preceding business day. If there is a misweighting in any security in the portfolio in excess of the acceptable variance, such as one hundred and fifty percent (150%) of the specified misweighting percentage, then the Trustee calculates an adjustment to the portfolio in order to bring the misweighting within the specified misweighting percentage, based on prices at the close of the market on the day in which such misweighting occurs.

In some other example embodiments, on a monthly basis, the Trustee performs a weighting analysis for each security in the portfolio, and calculates an adjustment to the portfolio in order to bring the misweighting within the specified misweighting percentage when the difference in weighting of a security between the portfolio and one of the underlying indexes exceeds the variance, such as one hundred percent (100%) of the specified misweighting percentage.

In still some other example embodiments, in addition to the above-mentioned adjustments, the Trustee makes additional periodic adjustments to the portfolio of the trust that may be misweighted by an amount within a specified misweighting amount.

Referring now to FIG. 6, the value of each trading unit, such as the depository receipts 320 of FIG. 3, fluctuates in relation to changes in the value of the portfolio of the trust, such as trust 310 of FIG. 3. FIG. 6 illustrates an operation flow for a process 600 for determining the value of each trading unit of the trust. The process 600 starts at operation 605 and proceeds to an index valuation operation 610 in which the value of each underlying index, such as underlying indexes 302, 304, 306, 308 of FIG. 3, is determined. An operation flow process 700 implemented by the index valuation operation 610 is depicted as module A of FIG. 6, which is described in more detail in FIG. 7.

The process 600 then proceeds to a totaling operation 615, which includes adding the total value of all of the underlying indexes and other assets. At any moment in time, the value of the trust equals the aggregate market value of the underlying indexes, such as the underlying indexes 302, 304, 306, 308 of FIG. 3. Proceeding now to a subtracting operation 620 and a dividing operation 625, the net asset value of the trust is determined by subtracting all liabilities (including accrued expenses and dividends payable) adding all other assets, and dividing the result by the total number of outstanding depository receipts, such as depository receipts 320 of FIG. 3. In some example embodiments, the expenses of the trust are accrued daily and reflected in the net asset value of the trust. Preferably, after reflecting waivers, but before reflecting credits, the trust accrues ordinary operating expenses at an annual rate. In some example embodiments, the net asset value of the trust is computed on each business day. The process 600 ends at operation 630.

Referring back now to FIG. 4, each of the underlying indexes determines its own market value according to its own formula. In some example embodiments, determining the market value of the trust includes determining the market value of each of the underlying indexes using the respective formula of each underlying index. For example, in one example embodiment, the underlying indexes may calculates their own market value by first determining a float-adjusted weight of each security within the underlying index and then calculating the total value of the index using the float-adjusted weight. Of course, a different formula may be used to calculate the market value of each underlying index.

FIG. 7 illustrates an operation flow chart for one example process 700 for determining the total value of each underlying index. The start of the process 700 is designated by module A. The process 700 then proceeds to a share determining operation 705 that determines an appropriate number of shares for each security in the underlying index. In one example embodiment, determining the appropriate number of shares includes determining the number of float shares available (i.e., the number of shares available for trading on the security exchange). The float-adjusted weight of an index determines the number of available float shares for each security in the index. The float adjustment excludes from the total value of each index the value of the securities that are not available for trading and are not part of the investing opportunity set. For example, in some example embodiments, the float adjustment excludes shares held by other listed companies and large holdings of private investors (i.e., 10% or more). In another example embodiment, the appropriate number of shares includes all outstanding shares for the security.

The process 700 then proceeds to a price determining operation 710 that determines a current price of each security in the underlying index. In one example embodiment, some of the portfolio securities in the underlying indexes are listed on one or more national securities exchanges or on the National Market System maintained by the NASDAQ Stock Market. Preferably, the current price of the security in such a case is generally based on the closing sale price on that day on the exchange deemed to be the principal market of the security. In various other example embodiments, the current price of the security is based on the closing price: (a) on the over-the-counter market; (b) on current bid prices; (c) on current bid prices for comparable stocks; (d) on the Trustee's appraisal of the value of the stocks in good faith on the bid side of the market; and (e) on any combination thereof.

A multiplying operation 715 multiplies the appropriate number of shares of the security by the current price of the security to obtain a total price for each security in the underlying index. A totaling operation 720 adds together the total prices of the securities in the underlying index. The process ends at operation 725 and returns to the process 600 shown in FIG. 6.

The details of FIGS. 6 and 7 can best be explained using an example application. For example, referring to FIG. 6, the determining operation 610 includes determining the value of the Dow Jones Index, the S&P 500 Index, the Russell 2000 Index, and the NASDAQ Composite Index. The value of each underlying index is determined according to the algorithm used by the underlying index.

Referring to FIG. 6, in one example embodiment, the index valuation operation 610 includes determining the value of the S&P 500 Index. One example embodiment of such an index valuation operation 610 is shown in FIG. 7. FIG. 7, in general, illustrates a market capitalization weighting process. In one example embodiment, the share determining operation 705 includes float-adjusting the shares of the stocks of the S&P 500 Index. Float-adjusting an index refers to when the value of an index is calculated by only counting shares available to investors and not each stock's total outstanding shares. In some example embodiments, the float-adjusted shares are used to calculate a weight factor or ratio. For example, the investable weight factor used by the S&P 500 Index is calculated using the following formula: IWF=(float-adjusted shares)/(total shares outstanding). In varying example embodiments, the appropriate number of shares of a stock include the total shares outstanding, the float-adjusted shares, and a quantity determined based on the same.

In one example embodiment, the price determining operation 710 includes determining the closing price of each stock of the S&P 500 Index. The multiplying operation 715 and the totaling operation 720 iteratively multiply the closing price of each stock by the appropriate number of shares of the stock and total the results. For example, the average value of the S&P 500 Index is calculated using the following formula:

$$Index = \frac{{\sum }_{j} ( {P}_{j} {S}_{j} {IWF}_{j} )}{Divisor} ;$$

where Pⱼ is the price of the stock j, Sⱼ is the total shares outstanding of stock j, and IWFⱼ is the investable weight factor. In some example embodiments, an average value is taken by dividing by the number of stocks in the Index or some other determined divisor, such as the Divisor listed in the above equation.

The index valuation process depicted in FIG. 7, or a similar process, is performed for each underlying index. Referring back to FIG. 6, one example embodiment of the totaling operation 615 totals the results obtained from the index valuation process performed for each underlying index. The subtracting operation 620 subtracts the expenses of the trust. Examples of expenses include, but are not limited to, ordinary operating expenses, the Trustee's fee, various governmental fees, federal and state registration fees, and taxes.

In one example embodiment, the dividing operation 625 includes dividing the value obtained from the subtracting operation 620 by a divisor. In some example embodiments, the divisor may include the number of trading units in the Trust, such as the depository receipts 320 of FIG. 3.

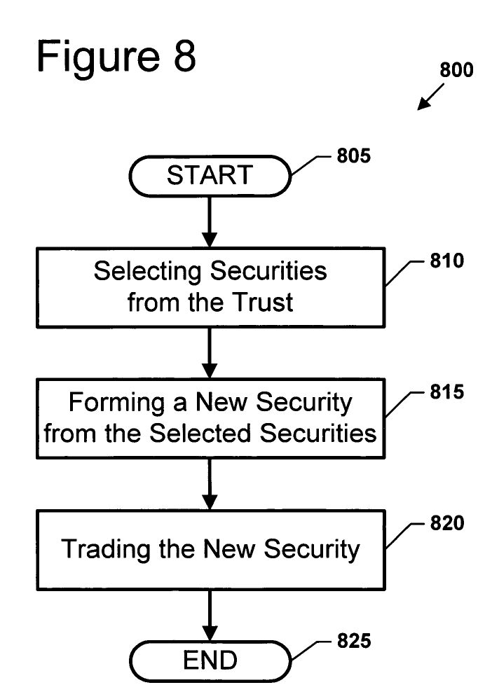

Referring now to FIG. 8, depository receipts, such as the depository receipts 320 of FIG. 3, can be formed from the trust portfolio as a whole, or from selected securities of the portfolio. For example, the stocks of the trust can be classified using various selection criteria and combined into separate securities. In some example embodiments, each stock in the trust is classified into one of several industries. Preferably, a new security for each industry is formed from the stocks of the Portfolio classified in that industry. In one example embodiment, each stock in the trust is classified into one of eleven industries based on the Dow Jones Global Classification Industrial Standards.

FIG. 8 illustrates an operation flow chart for a process 800 for trading a sector fund on a security exchange in accordance with one embodiment of the present disclosure. The process 800 begins at operation 805 and proceeds to a selecting operation 810, which selects securities from a trust, such as trust 310 of FIG. 3, based on selection criteria, such as an industry. A combining operation 815 combines the selected securities into a new security in a form operation 815, and a trading operation 820 trades the new security on a security exchange. The process 800 ends at operation 825.

For example, once a trust, such as trust 310 of FIG. 3, is formed, multiple industry specific securities can be formed from the trust. In one example embodiment, the selecting operation 810 includes selecting all securities held by the trust that have been classified into a specific industry, such as health care, by a classification system, such as the Down Jones Global Classification Industrial Standards. The combining operation 815 pools each of these selected securities together to form a new exchange traded fund having its own depository receipts. Each of these depository receipts can be traded on an exchange in the trading operation 820 similar to how the depository receipts of the trust, such as trust 310 of FIG. 3, are traded.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An exchange traded fund comprising:
a trust formed from shares of substantially all stocks composing at least a first and second index, a composition and weighting of each stock of the trust being substantially equal to a composition and weighting of each stock in the first and second index, the exchange traded fund being divided into a plurality of depository receipts, each depository receipt configured to be traded on a security exchange.

2. The exchange traded fund of claim 1, wherein the trust is formed from four stock indexes.

3. The exchange traded fund of claim 2, wherein the four stock indexes include the Dow Jones Industrial Average Index, the Russell 2000 Index, the S&P 500 Index, and the NASDAQ Composite Index.

4. The exchange traded fund of claim 1, wherein the plurality of depository receipts includes 50,000 depository receipts.

5. The exchange traded fund of claim 1, wherein the trust is passively managed.

6. The exchange traded fund of claim 1, wherein the trust is automatically adjusted.

7. The exchange traded fund of claim 1, wherein the exchange traded fund is formed from only selected stocks from the trust.

8. The exchange traded fund of claim 7, wherein the selected stocks from the trust are selected based on industry classification.

9. A method for trading an exchange traded fund, the method comprising:
creating a trust by obtaining shares of substantially all common stock in at least two underlying indices, the shares of stock obtained to match composition and weighting of shares of stock in the at least two underlying indices, and pooling all obtained common stocks into the trust;
dividing the trust into a plurality of depository receipts to obtain a number of depository receipts, each depository receipt representing an undivided ownership interest in the trust;
passively managing the trust by adding and deleting stocks to conform to periodic changes in identity to the at least two underlying indices; and
trading the depository receipts on a stock exchange.

10. The method of claim 9, wherein obtaining substantially all common stock in at least two indices includes:
obtaining all stocks included in the S&P 500 Index;
obtaining all stocks included in the NASDAQ Composite Index;
obtaining all stocks included in the Dow Jones Industrial Average Index; and
obtaining all stocks included in the Russell 2000 Index.

11. The method of claim 9, further comprising determining a value of the exchange traded fund by:
adding a value of each of the at least two underlying indices to obtain a total value;
subtracting expenses of the exchange traded fund; and
dividing the total value by the number of depository receipts.

12. The method of claim 11, wherein the value of each of the at least two underlying indices is determined by:
multiplying a closing price for each stock of the underlying index by an appropriate number of shares of the stock to obtain a total price for the stock; and
adding the total price for each stock of the underlying index.

13. The method of claim 9, further comprising:
selecting one or more stocks from the trust based on selection criteria;
forming a new security from the stocks selected based on the selection criteria; and
trading the new security on the stock exchange.

14. The method of claim 13, wherein the selection criteria is an industry classification.

15. An exchange traded fund comprising:
a trust, the trust formed from shares of selected securities composing at least one of a first and second index, the trust including at least one security from each of the first and second index, a composition and weighting of each security of the trust being substantially equal to a composition and weighting of the security in the index the security composes, the exchange traded fund being divided into a plurality of depository receipts, each depository receipt configured to be traded on a security exchange.

16. The exchange traded fund of claim 15, wherein the selected securities are selected from the first and second index based on industry classifications.

17. The exchange traded fund of claim 16, wherein the industry classifications are industry classifications of the Down Jones Global Classification Industrial Standards.

18. The exchange traded fund of claim 17, wherein the selected securities are classified as relating to real estate.

19. The exchange traded fund of claim 15, wherein each selected security composes at least one of a first, second, third, and fourth index.

20. The exchange traded fund of claim 15, wherein the trust is passively managed.
